(19) United States
(12) Patent Application Publication
(10) Pub. No.: US 2011/0012497 A1
(43) Pub. Date: Jan. 20, 2011

(54) PLATING STRUCTURE AND METHOD FOR MANUFACTURING ELECTRIC MATERIAL

(75) Inventors: Yoshinori Sumiya, Sakai-shi (JP); Kinya Sugie, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KYOWA ELECTRIC WIRE CO., LTD., Osaka (JP)

(21) Appl. No.: 12/835,362

(22) Filed: Jul. 13, 2010

(30) Foreign Application Priority Data
Jul. 15, 2009 (JP) 2009-166298
Nov. 13, 2009 (JP) 2009-259454

(51) Int. Cl. H01J 5/16; B32B 15/01; B05D 3/02

(52) U.S. Cl. 313/113; 428/647; 428/658; 428/642; 427/191; 427/192

(57) ABSTRACT

There is provided a plating structure obtained by heat-treating a silver-plated structure obtained by forming a tin-plated layer, an indium-plated layer, or a zinc-plated layer, having a thickness of 0.001 to 0.1 μm, on a surface of the silver-plated layer formed on a surface of a plating base. There is also provided a coating method for obtaining the plating structure which comprises the step of melting a particle deposit spottedly deposited at 2×10⁻⁶ to 8×10⁻⁶ g/cm² such that the spot-deposited particles have gaps therebetween as viewed above and the particles each having an average diameter of 20 to 80 nm do not pile up in a direction perpendicular to the surface of the silver layer to obtain a film.

### BACKGROUND OF THE INVENTION

1. Field of the Invention

The present invention relates to a plating structure that reduces the deterioration of the surface properties thereof, and in particular, relates to a plating structure of an electric component material that requires sulfurization prevention, and also relates to a method for manufacturing an electric component material having the plating structure. Specifically, the present invention relates to a plating structure of a material suitable for use as: a metal lead frame; a lead wire using a metal strip; a lead wire provided on a non-conductive (e.g., ceramic) substrate; a lead pin; a reflecting plate; and the electric contact material of a terminal, a connector, or a switch, and also relates to a method for manufacturing the material. More specifically, the present invention relates to a plating structure of an electric component material highly resistant to sulfurization, and also relates to a method for manufacturing the plating structure. In particular, the present invention relates to a plating structure of an electric material that has a high resistance to sulfurization, a low contact resistance, and a high surface reflectance, and also relates to a method for manufacturing the plating structure.

2. Description of the Related Art

In a light-emitting device having mounted thereon a light-emitting element such as an LED, a light-reflecting surface is provided so as to improve the brightness of the device (see JP 2008-205501 A and JP 2006-041179 A, for example). The light-reflecting surface is provided around the light-emitting element so that the light diffused around the lateral portion of the light-emitting element is directed, for example, in the direction of the principal axis of the emitted light. The light-reflecting surface is formed by metal plating. The most preferable is silver plating in view of its high reflectivity.

In a sulfur-containing environment, however, a silver-plated layer may be sulfurized with time and rise in temperature, and therefore the reflectance of the layer may decrease.

Consequently, techniques for forming a protective film of an organic substance on a reflecting surface (see JP 2008-010591 A and JP 2003-188503 A, for example) are disclosed.

Alternatively, a method for forming self-assembled monolayers of a substance, such as a semifluorinated sulfur-containing compound, on a metal substrate to thereby protect the surface of the substrate (see JP 2002-327283 A, for example) is known.

These remedies are effective to some extent, but do not necessarily achieve a satisfactory effect in the following respect. When the resin used in a package is cured in a mounting process, the rise in temperature caused by the curing may scatter a protective film that should serve to prevent the sulfurization of the silver-plated layer. This greatly reduces the effect of preventing sulfurization, and does not necessarily result in a sufficient effect of preventing the sulfurization of the reflecting surface, the sulfurization due to the heat generated in the light-emitting element, or the sulfurization of the device over a long period of use. In view of this, there is a need for a reflecting surface to be highly resistant to heat.

In addition, a silver-plated structure is widely used in the contacts of a switch (see JP 2008-248295 A, for example). Also in this silver-plated surface, however, a protective film that should serve to prevent the sulfurization of the silver-plated layer may be scattered with time and the rise in temperature caused when the switch is manufactured or caused due to the discharge resulting from switching on and off. This greatly reduces the effect of preventing sulfurization, and therefore the silver-plated layer may be sulfurized and the surface may be damaged. In view of this, there is a need for a plating contact to be highly resistant to heat.

Thus there is a need for a plating structure whose surface is not sulfurized and damaged with time and rise in temperature.

In addition, conventionally, in various applications, various metal base materials have been improved in resistance to corrosion, electrical connectivity, and the like by plating the surfaces of the materials with silver or a silver alloy. Such a surface is used in an LED, as a reflecting plate that makes use of its silver-specific reflection performance.

It is known, for example, that when a material is obtained by coating with a silver layer a surface of copper or a copper alloy that excels in electrical conductivity, thermal conductivity, mechanical strength, and workability, the obtained material has a high resistance to corrosion, a high electrical connectivity, and the like of silver, as well as excellent properties of a copper alloy. Such a material is widely used in the electric apparatus field, as an electric contact material and the material of a lead.

A silver surface, however, is likely to be discolored by sulfurization. Consequently, a technique for forming a tin or tin alloy layer on a silver surface in view of their soldering properties (see JP 09-078287, for example) is disclosed.

In this case, the thicker the tin or tin alloy layer, the higher the contact resistance. Further, the reflectance of the surface decreases, and therefore the original brightness and reflection performance of silver are lost.

Alternatively, an organic thin film may be formed on a silver surface so as to prevent sulfurization. An organic thin film, however, lacks resistance to heat, and therefore has a drawback in resistance to sulfurization at high temperature.

### SUMMARY OF THE INVENTION

It is an object of the present invention to provide a plating structure whose surface is not sulfurized and damaged with time and rise in temperature. It is another object of the present invention to provide a light-emitting element accommodating support including a reflecting surface having a plating structure that is highly resistant to heat so as to prevent sulfurization, the light-emitting element accommodating support used for a light-emitting device that has a light-emitting element mounted thereon.

It is yet another object of the present invention to provide an electric component coating method for obtaining an electric component coating material that has the plating structure, is unlikely to be discolored by sulfurization, has the original brightness of silver, and has a low contact resistance.

In a first preferred embodiment, a plating structure according to the present invention is obtained by heat-treating a silver-plated structure formed by the steps of: forming a silver-plated layer on a surface of a plating base; and forming a tin-plated layer, an indium-plated layer, or a zinc-plated layer, having a thickness of 0.001 to 0.1 μm, on a surface of the silver-plated layer.

In a second preferred embodiment, a light-emitting element accommodating support according to the present invention includes a recess for accommodating a light-emitting element, the light element accommodating support reflects light on a peripheral wall of the recess, wherein the plating structure is formed on the peripheral wall of the recess and a body of the light-emitting element accommodating support in the plating structure serves as the plating base.

In a third preferred embodiment, a light-emitting device according to the present invention comprises: the light-emitting element accommodating support; and a light-emitting element mounted on the light-emitting element accommodating support.

In a fourth preferred embodiment, a switch contact according to the present invention includes a plated section having the plating structure.

In a fifth preferred embodiment, a component terminal according to the present invention includes a plated section having the plating structure.

In a sixth preferred embodiment, a component contact according to the present invention includes a plated section having the plating structure.

In a seventh preferred embodiment, a coating method for obtaining the plating structure according to the present invention comprises the steps of: arranging tin, or indium spot-deposited particles or zinc spot-deposited particles spottedly deposited by a particle deposition method on a surface of a silver layer formed on a surface of a base material such that the spot-deposited particles have gaps therebetween as viewed from above, and do not pile up in a direction perpendicular to the surface of the silver layer; and melting the spot-deposited particles by heating in a non-oxidizing atmosphere a particle deposit to obtain a film, an average diameter of the spot-deposited particles being from 20 to 80 nm, a weight per unit area of the tin or the indium spot-deposited particles or the zinc spot-deposited particles formed on the surface of the silver layer being from 2×10⁻⁶ to 8×10⁻⁶ g/cm².

### ADVANTAGES OF THE INVENTION

The present invention provides a plating structure whose surface is not sulfurized and damaged with time and rise in temperature. Further, the present invention provides a light-emitting element accommodating support including a reflecting surface having a plating structure highly resistant to heat, the light-emitting element accommodating support used for a light-emitting device that has a light-emitting element mounted thereon.

The present invention provides an electric contact material, an electric component reflecting material, and another electric component coating material that are unlikely to be discolored by sulfurization, have the original brightness of silver, and have a low contact resistance.

For a full understanding of the present invention, reference should now be made to the following detailed description of the preferred embodiments of the invention as illustrated in the accompanying drawings.

### BRIEF DESCRIPTION OF THE DRAWINGS

FIG. 1(a) is a cross-sectional view illustrating an example of an aspect of a silver-plated structure for obtaining a plating structure according to the present invention;

FIG. 1(b) is a cross-sectional view illustrating an example of another aspect of the silver-plated structure for obtaining the plating structure according to the present invention;

FIG. 2 is a cross-sectional view illustrating an example of an aspect of a lead frame having the plating structure according to the present invention;

FIG. 3 is a cross-sectional view illustrating an example of the structure of an LED lamp using an electric component coating material manufactured by a coating method for preventing sulfurization according to the present invention;

FIG. 4 is a graph of the reflectances of samples and comparative samples that have the plating structure according to the present invention;

FIG. 5 is a cross-sectional schematic view showing an aspect of a particle deposit used in the present invention;

FIG. 6 is a cross-sectional schematic view showing a particle deposit containing spottedly deposited particles (hereinafter referred to as “spot-deposited particles”) arranged in a planar manner such that adjacent spot-deposited particles contact each other, that is, have no gaps therebetween;

FIG. 7 is a cross-sectional schematic view showing the particle deposit containing the spot-deposited particles arranged in three dimensions such that adjacent spot-deposited particles have no gaps therebetween, and also pile up in the direction perpendicular to the surface of a silver layer;

FIG. 8 is a cross-sectional schematic view showing an electric component coating material manufactured by a coating method for preventing sulfurization according to the present invention;

FIG. 9 is a micrograph illustrating an aspect of a particle deposit used in the present invention; and

FIG. 10 is a micrograph illustrating an aspect of a particle deposit used in a comparative example.

### DESCRIPTION OF THE PREFERRED EMBODIMENTS

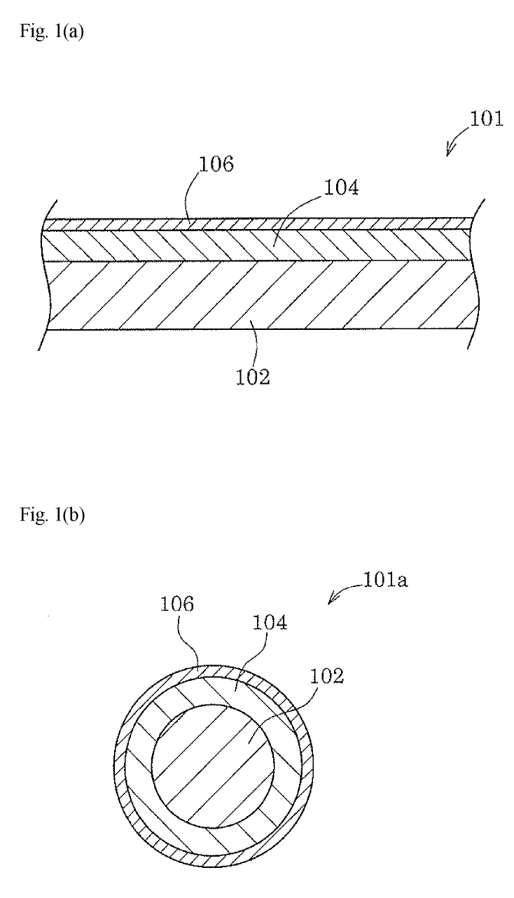

The preferred embodiments of the present invention will now be described with reference to FIGS. 1-10 of the drawings. Identical elements in the various figures are designated with the same reference numerals.

As shown in FIG. 1(a), a plating structure according to the present invention is a plating structure obtained by heat-treating at from 150 to 600° C. a silver-plated structure 101 which comprises the steps of: forming a silver-plated layer 104 on the surface of a plating base 102; and forming a protective plating layer 106 with a thickness of 0.001 to 0.1 μm on the surface of the silver-plated layer 104. The heat treatment time is preferably from 1 to 60 seconds.

The base 102 is a base that can be silver-plated. The base 102 may be formed of a metal sheet. For example, the metal sheet may be, but is not limited to, a copper-based metal (e.g., brass) sheet, an iron-based metal sheet, or a stainless sheet. Note that normally, in the case of using a copper-based metal sheet, the plating base 102 is copper-plated (not shown) as an undercoat before being silver-plated. In the case of using a stainless sheet, the plating base 102 is, for example, nickel-plated (not shown) as an undercoat before being silver-plated.

Alternatively, the base 102 may be obtained by forming a conductive film on the surface of a ceramic or resin base by metallization such as electroless plating, vapor deposition, or the diffusion formation of a metal layer.

The base 102 is not limited to a sheet-like base as shown in FIG. 1(a), but may be a rod-like base. That is, as shown in FIG. 1(b), the plating structure according to the present invention may be a plating structure obtained by heat-treating at from 150 to 600° C. a silver-plated structure 101a obtained by sequentially forming a silver-plated layer 104 and then a protective plating layer 106 concentrically around the circumferential surface of the base 102 of a long member such as a metal wire.

The protective plating layer 106 preferably has a thickness of 0.001 to 0.1 μm. When the thickness of the protective plating layer 106 is within this range, it is possible to prevent the progress of the sulfurization of the silver-plated layer 104 with time and heat. Further, the plating structure has silver-specific surface properties such as a high light reflectivity, a high surface electrical conductivity, and a silver-specific brightness. When the thickness of the protective plating layer 106 is below this range, it is not possible to obtain a sufficient resistance to sulfurization. When the thickness of the protective plating layer 106 is above this range, it is not possible to obtain silver-specific surface properties such as a high light reflectivity and a high surface electrical conductivity.

The metal used to form the protective plating layer 106 may be, for example, such as tin, indium, or zinc. The most preferable of these is tin or indium in view of their resistances to sulfurization.

In the plating structure according to the present invention, the protective plating layer 106 may contain an alloy with the silver that has migrated from the silver-plated layer 104 heated as described above.

The silver-plated layer 104 can be obtained by silver-plating the surface of the base 102 in the usual manner. The silver-plated layer 104 may be formed by another film forming method such as electroless plating. The silver-plated layer 104 preferably has a thickness of 0.1 to 10 μm. The surface of the base 102 to be silver-plated has preferably been underplated with nickel or the like.

The silver-plated structure 101 heat-treated at from 150 to 600° C. provides the silver-plated layer 104 with an excellent effect of preventing sulfurization, although the protective plating layer 106 is as thin as having a thickness of 0.001 to 0.1 μm. This is presumed to be because an alloy structure is generated by the heat treatment at the interface between the silver-plated layer 104 and the protective plating layer 106, and guards against sulfurization. The heat treatment temperature is more preferably from 250 to 300° C. so as to obtain an excellent surface performance such as an effect of preventing sulfurization and a high reflectance. The heat treatment time is preferably from 1 to 60 seconds.

When the heat treatment temperature is below 150° C., the diffusion effect of the tin-plated layer obtained by the heating may be insufficient. This may not result in a sufficient effect of preventing sulfurization. When the heat treatment temperature is above 600° C., the physical properties of the base change due to the annealing of the base. This impairs the mechanical properties of the base that are required for practical use.

The silver-plated layer 104 preferably has a thickness of 1 to 10 μm.

The silver-plated layer 104 and the protective plating layer 106 can be formed by electro plating or electroless plating.

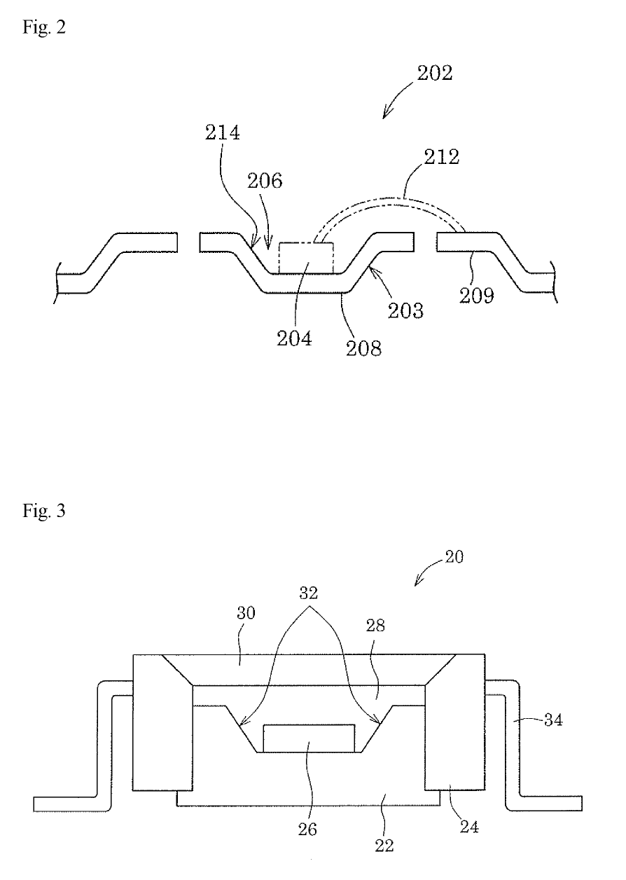

FIG. 2 shows an example of an aspect of a light-emitting element accommodating support including the plating structure according to the present invention. A light-emitting element accommodating support 202 includes a substrate 203 referred to as a “lead frame”, the substrate 203 having a recess 206 for accommodating a light-emitting element 204. The substrate 203 (lead frame) includes a land 208 and a lead 209, the recess 206 formed in the land 208. The light-emitting element 204 is mounted on the recessed surface of the recess 206, one terminal of the light-emitting element 204 being continuous with the land 208, the other terminal being continuous with the lead 209 through a wire 212.

A reflecting surface 214 is formed on the peripheral surface of the recess 206. In the present invention, the reflecting surface 214 is obtained by heat-treating at from 150 to 600° C. a substrate formed by the steps of: silver-plating the peripheral surface of the recess 206; and forming a thin tin-plated layer, a thin indium-plated layer, or a thin zinc-plated layer on the surface of the silver-plated layer by, for example, flash plating.

The light-emitting element 204 may be, for example, an LED.

A light-emitting device is obtained by mounting the light-emitting element 204 in the aspect shown in FIG. 2. Conventionally, in the mounting process of the light-emitting element 204, a sulfurization prevention film is scattered due to heating for, for example, molding the case, wire-bonding the element with a chip, or curing resin. This reduces the effect of preventing sulfurization, and therefore makes the progress of the sulfurization of the reflecting surface. Thus the reflectance of the reflecting surface decreases. The emission of light from the light-emitting element 204 generates heat. If the reflecting surface has a conventional silver-plated layer, the generated heat reduces the effect of preventing sulfurization in a similar manner to the above, and therefore makes the progress of the sulfurization of the reflecting surface.

The reflecting surface 214 of the light-emitting element accommodating support 202 according to the present invention only causes extremely slight sulfurization with time and the rise in temperature on the reflecting surface, and therefore can maintain a high reflectance over a long period of time.

FIG. 3 shows an example of the structure of an LED lamp 20 employing an electric component coating material according to the present invention. The LED lamp 20 includes an LED 26 mounted on a base 22, and a casing 24 housing the LED 26 and the base 22. The casing 24 is filled with phosphor 28, the LED 26 buried in the phosphor 28, and further, a transparent resin cover 30 is provided on the top surface of the phosphor 28. The numerical symbol “34” represents a lead wire. As the base material of the body of the base 22, a metallic (e.g., copper alloy) member or a metalized ceramic member is used, and a reflecting surface 32 is formed on the surface of the base 22, the reflecting surface 32 silver-plated and tin-plated or indium-plated according to the present invention. The reflecting surface 32 has as high reflectance as that of a silver surface, and is hardly discolored due to sulfurization with time. Thus the LED lamp 20 emits a large amount of light, and only slightly decreases in the amount of emitted light with time.

The plating structure according to the present invention is applicable to a switch contact. A switch contact including the plating structure according to the present invention has a silver-specific brightness and a high surface electrical conductivity, and only slightly changes in these surface properties due to sulfurization even with long-term use. For example, a switch contact or the like may be assembled by: mounting an element on a lead frame; bonding, and molding with resin, the element and the lead frame; and plating, and subsequently pressing, the element and the lead frame.

The plating structure according to the present invention is applicable to a contact or a terminal of an electric apparatus. A contact or a terminal including the plating structure according to the present invention has a silver-specific brightness and a high surface electrical conductivity, and only slightly changes in these surface properties due to sulfurization even with long-term use.

The effects of the present invention are confirmed by the following experimental examples.

### EXPERIMENTAL EXAMPLES

### Base Samples

As an equivalent of the plating base 102 shown in FIG. 1(a) or FIG. 1(b), a 1-cm square piece of a lead frame copper alloy strip (product name “EFTEC3” manufactured by Furukawa Electric Co., Ltd.) was used. A base sample was obtained by underplating one side of the piece with copper to a thickness of 1 μm, and subsequently silver-plating the underplated side to a thickness of 2 μm. This base sample was tin-plated, heat-treated, and the like in accordance with the following experimental levels.

### <Experimental Sample Levels>

L-1: blank (the base sample).

L-2: a tin layer with a thickness of 0.01 μm was formed on the silver surface of the base sample by flash plating.

L-3: a tin layer with a thickness of 0.01 μm was formed on the silver surface of the base sample by flash plating, and subsequently the sample was heat-treated at 300° C. for 10 seconds.

L-4: a tin layer with a thickness of 0.02 μm was formed on the silver surface of the base sample by flash plating.

L-5: a tin layer with a thickness of 0.02 μm was formed on the silver surface of the base sample by flash plating, and subsequently the sample was heat-treated at 300° C. for 10 seconds.

L-6: a tin layer with a thickness of 0.2 μm was formed on the silver surface of the base sample by flash plating.

L-7: an organic film was formed on the silver surface of the base sample so as to prevent sulfurization, using a sulfurization inhibitor that forms self-assembled monolayers.

Table 1 shows the list of the experimental sample levels and the contents thereof.

### <Sulfurization Test>

The samples were subjected to sulfurizing treatment by immersing the samples at room temperature for 5 minutes in an immersion liquid obtained by adding 400 cc of water to 20 mL of a solution containing 6% by weight of ammonium sulfide. The pieces that had been immersed were: cleaned with pure water; immersed in methanol that had replaced the pure water; and were blown in a nitrogen flow. Subsequently, these samples were heated at the respective temperatures (Table 1) for an hour to thereby promote sulfurization. The degrees of sulfurization were visually determined. This heating after the sulfurizing treatment corresponds to an accelerated test for long-term sulfurization. The heating also corresponds to rise in temperature in assembling and using an apparatus.

### <Criteria>

Very good: the brightness and the color of the silver surface are maintained (before the sulfurizing treatment). Alternatively, the brightness and the color of the silver surface are maintained, with no sulfurization observed on the surface (after the sulfurizing treatment).

Good: the brightness and the color of the silver surface are almost maintained (before the sulfurizing treatment). Alternatively, the brightness and the color of the silver surface are almost maintained, with almost no sulfurization observed on the surface (after the sulfurizing treatment).

Average: the brightness and the color of the silver surface are maintained to an acceptable degree (before the sulfurizing treatment). Alternatively, the brightness and the color of the silver surface are maintained to an acceptable degree, with slight sulfurization observed on the surface (after the sulfurizing treatment).

Poor: the brightness and the color of the silver surface are lost (before the sulfurizing treatment). Alternatively, the brightness and the color of the silver surface are lost, with sulfurization observed on the surface (after the sulfurizing treatment).

### <Reflectance>

The reflectances of the experimental samples before and after the sulfurization test were measured in accordance with JIS R 3106, using the light from a D65 light source in the wavelength range from 380 to 780 nm.

TABLE 1

| Experimental | Thickness of tin- | Heat treatment | Organic film on |
|---|---|---|---|
| sample | plated layer | after plating | the surface |
| L-1 | Nil | — | No |
| L-2 | 0.01 μm | No | No |
| L-3 | 0.01 μm | Yes | No |
| L-4 | 0.02 μm | No | No |
| L-5 | 0.02 μm | Yes | No |
| L-6 | 0.2 μm | No | No |
| L-7 | Nil | — | Yes |

### <Test Result>

Table 2 shows the result of the sulfurization test.

TABLE 2

| Heating temperature | Before | | | | | | |
|---|---|---|---|---|---|---|---|
| after sulfurizing | sulfurization | | | | | | |
| treatment | test | No heating | 100° C. | 130° C. | 150° C. | 170° C. | 180° C. |
| L-1 | Very good | Poor | Poor | Poor | Poor | Poor | Poor |
| L-2 | Very good | Very good | Good | Poor | Poor | Poor | Poor |
| L-3 | Very good | Very good | Good | Good | Good | Good | Good |
| L-4 | Good | Good | Average | Average | Poor | Poor | Poor |
| L-5 | Good | Good | Good | Good | Good | Good | Good |
| L-6 | Poor | — | — | — | — | — | — |
| L-7 | Very good | Poor | Poor | Poor | Poor | Poor | Poor |

It is found from Table 2 that in the case of the samples having a tin layer with a thickness of 0.01 μm (L-2 and L-3), the brightness and the color of the silver surface are maintained before the sulfurizing treatment. In the case of the samples having a tin layer with a thickness of 0.02 μm (L-4 and L-5), the brightness and the color of the silver surface are almost maintained before the sulfurizing treatment. In the case of the sample heat-treated at 300° C. for 10 seconds after the tin layer has been formed thereon (L-3), the brightness and the color of the silver surface are almost maintained, with almost no sulfurization observed on the surface even by the heating after the sulfurizing treatment, although the tin layer is as extremely thin as 0.01 μm thick. In the case of the samples not heat-treated after the tin layer has been formed thereon (L-2 and L-4), the brightness and the color of the silver surface are lost when the tin layer is as extremely thin as 0.01 μm thick (L-2), because the surface is sulfurized by the heating at high temperatures after the sulfurizing treatment. On the other hand, when the tin layer has a thickness of 0.02 μm (L-4), the surface is sulfurized to a relatively small degree by the heating after the sulfurizing treatment, although the sample is not heat-treated after the tin layer has been formed thereon. In the case of the sample having a tin layer with a thickness of 0.2 μm (L-6), the brightness and the color of the silver surface are lost even before the sulfurizing treatment, due to the masking effect caused by the tin layer. In the case of the sample having an organic film formed on the silver surface of the base sample (L-7), the brightness and the color of the silver surface are lost because the surface is sulfurized by the sulfurizing treatment.

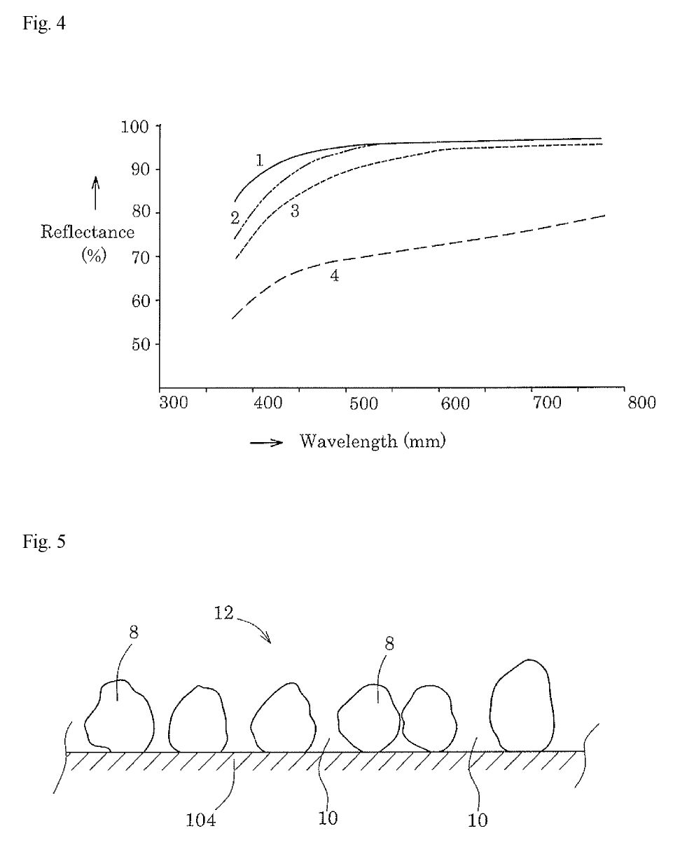

FIG. 4 shows the result of the measurement of the reflectances. The reflectances of the following four types of samples were measured, using the experimental samples L-3 and L-7.

1. the experimental sample L-3

2. the experimental sample L-3 subjected to sulfurizing treatment

3. the experimental sample L-3 heated at 180° C. for an hour after being subjected to sulfurizing treatment

4. the experimental sample L-7 heated at 180° C. for an hour after being subjected to sulfurizing treatment

It is found from FIG. 4 that in the case of the sample having an organic film formed on the silver surface of the base sample (L-7), the reflectance significantly decreases by the sulfurizing treatment (4). In the case of the sample heat-treated at 300° C. for 10 seconds after a tin layer with a thickness of 0.01 μm had been formed thereon (L-3), the reflectance was so high as to be 93% at a wavelength of 450 nm, and further, 80% or more in almost the entire wavelength range of visible light. The reflectance of L-3 only slightly decreased even by the sulfurizing treatment. Consequently, the reflectance of L-3 after the sulfurizing treatment was far higher than the reflectance of L-7 after the sulfurizing treatment, L-7 being that of a conventional product. For example, the reflectance of (4) was 67% at a wavelength of 450 nm, whereas the reflectance of (2) was 90% at a wavelength of 450 nm. Also in the case of the sample L-3 heated at 180° C. for an hour after being subjected to the sulfurizing treatment (3), the reflectance only slightly decreased to, for example, 85% at a wavelength of 450 nm.

The following shows an example of an aspect of a method for manufacturing an electric component coating material by a coating method for obtaining the plating structure according to the present invention. First, a base 102 is prepared, with a silver-plated layer 104 (FIG. 1(a) or FIG. 1(b)) formed thereon. Then tin particles, indium particles, or zinc particles are deposited on the surface of the silver-plated layer 104 by a particle deposition process. In this case, current is applied for a short time so that, as shown in FIG. 5, spot-deposited particles 8, deposited in the form of minute masses by the particle deposition process, are arranged on the surface of the silver-plated layer 104 such that adjacent spot-deposited particles 8 are, at least partially, sparsely placed in a planar manner so as to have gaps 10 therebetween, and do not pile up in the direction perpendicular to the surface of the silver-plated layer 104. “Sparsely placed in a planar manner” refers to the state where tin particles, indium particles, or zinc particles are deposited in a given region on the surface of the silver-plated layer 104 by a particle deposition process such as plating, and where the area of the silver-plated layer 104, in the given region, visible from above is 15% or more of the area of the entire given region. The area of the silver-plated layer 104, in the given region, visible from above is preferably from 15 to 50% of the area of the entire given region. When the value exceeds 50%, a uniform thin film 7 cannot be obtained in the present invention.

The particle deposition process performed in the present invention is a process of depositing desired metallic particles on a substrate by means selected from chemical means, electric means, and physical means. Specifically, the process may use, for example, an electroplating method, an electroless plating method, a vacuum vapor deposition method, a chemical vapor deposition method, a sputtering method, a plasma deposition method, or a cluster ion beam method. The most preferable of these is an electroplating method in view of its ability to reduce manufacturing costs.

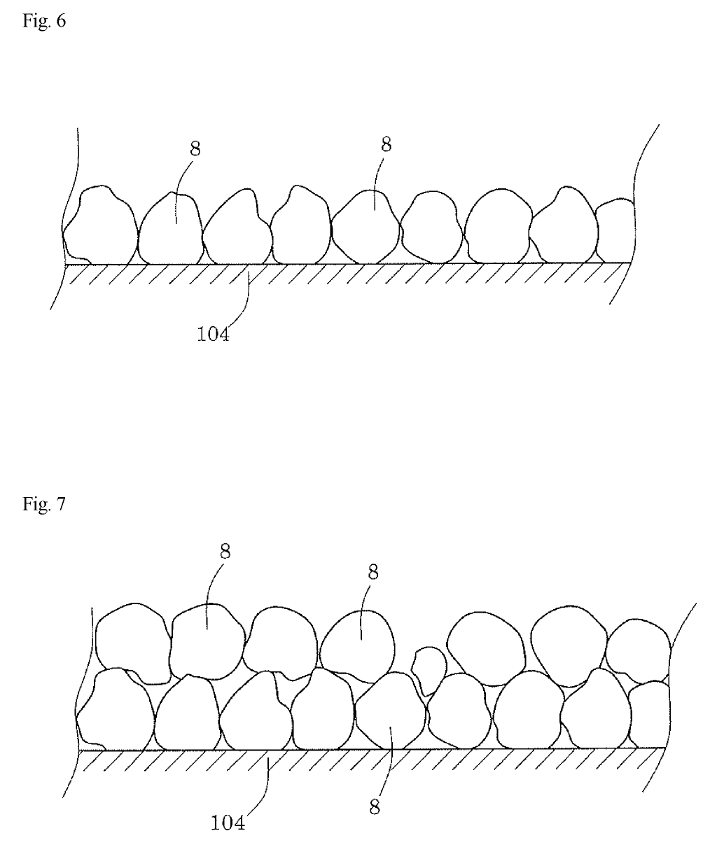

For example, with the use of an electroplating process as the particle deposition process, when the current application time is lengthened, the spot-deposited particles 8 are, as shown in FIG. 6, arranged in a planar manner such that adjacent spot-deposited particles 8 contact each other, that is, have no gaps therebetween. Alternatively, as shown in FIG. 7, the spot-deposited particles 8 are arranged in three dimensions such that adjacent spot-deposited particles 8 have no gaps therebetween, and also pile up in the direction perpendicular to the surface of the silver-plated layer 104.

For example, when an electroplating process is used as the particle deposition process, the current application time is preferably selected in the range from 1 to 120 seconds so that, as shown in FIG. 5, adjacent spot-deposited particles 8 may be sparsely placed in a planar manner so as to have gaps 10 therebetween. As well as this, the concentration of the tin constituent, the indium constituent, or the zinc constituent in the plating solution is preferably adjusted to be lower than that of normal plating conditions, for example, from ⅕ to 1/20 of the concentration of a normal plating solution (e.g., 50 to 100 g/L tin methanesulfonate).

The particle diameter of each of the spot-deposited particles 8 is preferably from 20 to 80 nm so as to obtain a uniform film for the electric component coating material according to the present invention. The particle diameter is more preferably from 30 to 60 nm so as to achieve an optimal balance between excellent reflecting properties and the sulfurization prevention performance, of the electric component coating material. It is possible to obtain the spot-deposited particles 8 having these particle diameters by, for example: using a plating bath obtained by adjusting the concentration of the tin constituent in a normal tin plating bath to from ⅕ to 1/20 thereof; and selecting the density of applied current in the range from 0.5 to 10 A/dm². In this case, the current application time is adjusted according to the concentration of the plating solution. Alternatively, it is possible to obtain the spot-deposited particles 8 having particle diameters in the range close to from 20 to 30 nm by, for example, applying pulsed current in the order of microseconds.

In the present invention, a film is obtained by heating in a non-oxidizing atmosphere, and melting a particle deposit 12, as shown in FIG. 5, containing tin, indium, or zinc spot-deposited particles 8 arranged on the surface of the silver-plated layer 104 such that the spot-deposited particles 8 are, at least partially, sparsely placed so as to have gaps therebetween, and do not substantially pile up in the direction perpendicular to the surface of the silver-plated layer 104, the tin, indium, or zinc spot-deposited particles 8 spottedly deposited on the surface of the silver-plated layer 104 by a particle deposition process. The non-oxidizing atmosphere refers to an atmosphere where tin, indium, or zinc is negligibly oxidized, at most. In this non-oxidizing atmosphere, for example, the following types of heating may be performed: heating in inert gas such as nitrogen; heating in vacuum; or heating in a reducing flame. The heating temperature is preferably the melting point of the deposited metal (tin, indium, or zinc) or higher and 600° C. or lower.

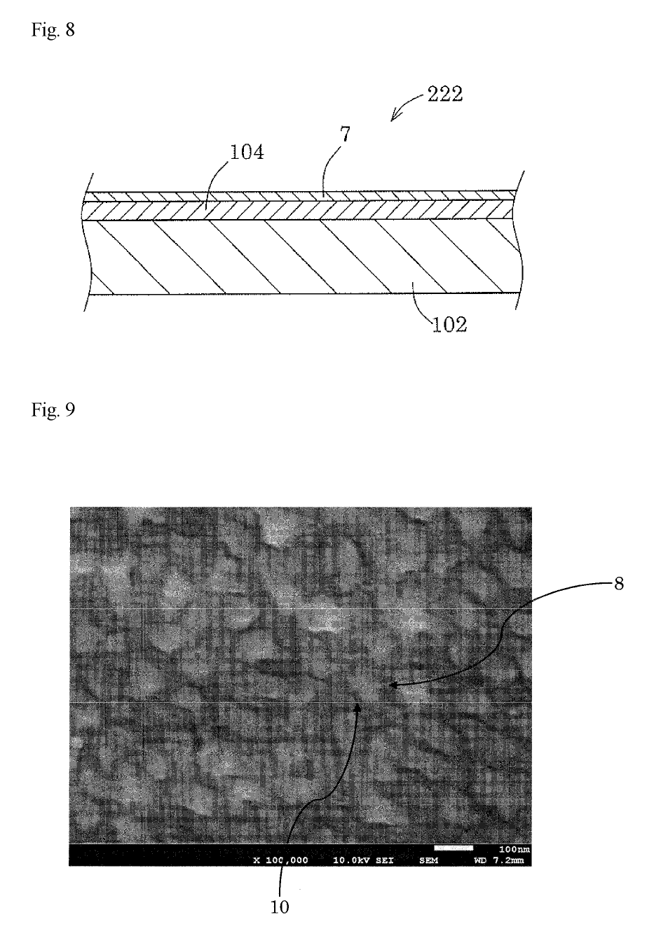

Thus, an electric component coating material 222 as shown in FIG. 8 is obtained by: forming a silver-plated layer 104 on the surface of the base 102; and forming a thin film 7 of tin or a tin alloy, of indium or an indium alloy, or of zinc or a zinc alloy on the surface of the silver-plated layer 104.

The weight per unit area of the spot-deposited particles 8 contained in the particle deposit 12 on the surface of the silver-plated layer 104 is preferably from 2×10⁻⁶ to 8×10⁻⁶ g/cm². This value corresponds to the weight per unit area of the spot-deposited particles 8 when assumed to form a thin film of tin obtained by melting and solidifying the spot-deposited particles 8 on the surface of the silver-plated layer 104, the thin film of tin has a thickness of approximately 3 to 11 nm. For example, in the case of using tin, the thin film 7 is presumed to be in fact formed of tin and/or an alloy of silver and tin. Thus, for example, when the weight per unit area of the spot-deposited particles 8 contained in the particle deposit 12 on the surface of the silver-plated layer 104 is 3×10⁻⁶ g/cm², the thin film 7 is presumed to have a thickness of 4 nm or more, containing a thermal diffusion layer of silver and tin. When the weight per unit area of the spot-deposited particles 8 contained in the particle deposit 12 on the surface of the silver-plated layer 104 is 8×10⁻⁶ g/cm², the thin film 7 is presumed to have a thickness of 11 nm or more. In either case, the weight per unit area of tin or indium present in the thin film 7 is the same as the weight per unit area of the spot-deposited particles 8 contained in the particle deposit 12 on the surface of the silver-plated layer 104.

The weight per unit area of the spot-deposited particles 8 contained in the particle deposit 12 on the surface of the silver-plated layer 104 is more preferably from 5×10⁻⁶ to 7×10⁻⁶ g/cm² so as to achieve a balance between the contact resistance, the brightness of silver, and the resistance to sulfurization.

It is possible to measure with an X-ray fluorescence analyzer the amount per unit area of tin, indium, or zinc present in the thin film 7, and the weight per unit area of the spot-deposited particles 8 contained in the particle deposit 12 on the surface of the silver-plated layer 104.

When the electric component coating material is obtained by the method for manufacturing the electric component coating material according to the present invention, the obtained electric component coating material is unlikely to be sulfurized, has a contact resistance close to that of silver, and has a silver-specific brightness. In the present invention, when tin, indium, and zinc are compared to each other, the electric component coating material using indium is less likely to be sulfurized and therefore is more preferable than the electric component coating material using tin. The electric component coating material using tin is less likely to be sulfurized and therefore is more preferable than the electric component coating material using zinc.

When the weight per unit area of the spot-deposited particles 8 contained in the particle deposit 12 on the surface of the silver-plated layer 104 is below 2×10⁻⁶ g/cm², the sulfurization prevention performance of the obtained electric component coating material is poor. When the weight per unit area of the spot-deposited particles 8 contained in the particle deposit 12 on the surface of the silver-plated layer 104 is over 11×10⁻⁶ g/cm², the contact resistance of the obtained electric component coating material is excessive, and therefore the silver-specific brightness is lost. Further, when the particle deposit to be used contains the tin, indium, or zinc spot-deposited particles 8 arranged on the surface of the silver-plated layer 104 such that almost all the adjacent spot-deposited particles 8 contact each other (which is referred to as a “gap-free state”), it is difficult to form a uniform thin film of a desired thickness by heating. This results in an excessive contact resistance of the obtained electric component coating material, and therefore the silver-specific brightness is lost. The gap-free state refers to the state where at least four of a plurality of spot-deposited particles surrounding a particular spot-deposited particle in a planar manner contact the surrounded particular spot-deposited particle. Furthermore, when spot-deposited particles are deposited in a given region on the surface of the silver-plated layer 104 by a particle deposition process, and when the area of the silver-plated layer 104, in the given region, visible from above is below 15% of the area of the entire given region, it is difficult to form a uniform thin film of a desired thickness by heating. This results in an excessive contact resistance of the obtained electric component coating material, and therefore the silver-specific brightness is lost.

Moreover, when the particle deposit to be used contains the spot-deposited particles 8 arranged so as to pile up in the direction perpendicular to the surface of the silver-plated layer 104, it is also difficult to form a uniform thin film of a desired thickness by heating. This results in an excessive contact resistance of the obtained electric component coating material, and therefore the silver-specific brightness is lost.

In addition, when the particle deposit 12 is heated in an oxidant atmosphere, the fluidity of the oxidized tin, indium, or zinc decreases. Thus, the spot-deposited particles 8 do not form a uniform film, and therefore a uniform thin film 7 cannot be obtained.

### EXAMPLES

### Example 1

A frame in the shape of the substrate 203 shown in FIG. 2 was silver-plated and tin-plated. As the material of the frame that serves as the base, a lead frame copper alloy strip (“EFTEC3” manufactured by Furukawa Electric Co., Ltd.) was used, and the frame was formed by stamping the lead frame copper alloy strip. The frame was subjected to degreasing treatment, was subsequently acid rinsed with 5% sulfuric acid, and was underplated with copper in a bright copper sulfate bath (200 g/L copper sulfate, 50 g/L sulfuric acid, and a 2 mL/L commercial brightening agent). The film of the copper underplating had a thickness of 1.0 μm. Subsequently, the frame was bright silver-plated to a thickness of 2 μm in a bright silver cyanide bath (35 g/L silver cyanide, 90 g/L potassium cyanide, and 10 g/L potassium carbonate). Further, the frame was tin-plated to a thickness of 0.01 μm in an alkanolsulfonate bath (18 g/L tin(II), 100 g/L free acid, and 10 mL/L semi-brightening agent), and was subsequently heat-treated at 250° C. for 10 seconds. Thus, a lead frame was obtained. A sulfurization test gave a similar result to that of L-3 of Table 1.

### Example 2

A stainless (SUS304) sheet with a thickness of 1 mm and 1 cm square was used as the base, was subjected to degreasing treatment, was subsequently acid rinsed with 5% sulfuric acid, and was underplated with copper in a bright copper sulfate bath (200 g/L copper sulfate, 50 g/L sulfuric acid, and a 2 mL/L commercial brightening agent). The film of the copper underplating had a thickness of 1.0 μm. Subsequently, the sheet was bright silver-plated to a thickness of 2 μm in a bright silver cyanide bath (35 g/L silver cyanide, 90 g/L potassium cyanide, and 10 g/L potassium carbonate). Further, the sheet was tin-plated to a thickness of 0.01 μm in an alkanolsulfonate bath (18 g/L tin(II), 100 g/L free acid, and 10 mL/L of semi-brightening agent), and was subsequently heat-treated at 500° C. for 10 seconds. Thus a bright sheet was obtained. A sulfurization test gave a similar result to that of L-3 of Table 1.

### Comparative Example 1

A lead frame was obtained in a similar manner to that of Example 1, except that the heat treatment temperature after the tin plating was 100° C. A sulfurization test gave a similar result to that of L-2 of Table 1.

### Example 3

A substrate was obtained by underplating a brass strip material having a thickness of 0.3 mm with nickel to a thickness of 0.5 μm. The surface of the substrate was silver-plated to a thickness of 2 μm. Thus a base sample was obtained.

A particle deposit was obtained by tin-plating the base sample under the following conditions:

Plating solution composition: methanesulfonic acid: 100 g/L
tin methanesulfonate: 5 g/L
surfactant: 3 g/L

Plating temperature: 42° C.

Current density: 2 A/dm²

Current application time: 4 seconds

Like the particle deposit shown in FIG. 9, the obtained particle deposit contained tin spot-deposited particles 8 arranged on the surface of the base sample such that the tin spot-deposited particles 8 had gaps 10 therebetween as viewed from above, and did not pile up in the direction perpendicular to the surface of the base sample. The average diameter of the spot-deposited particles 8 was 50 nm. Further, the amount of tin in the particle deposit measured with an X-ray fluorescence analyzer (manufactured by SII NanoTechnology Inc.) was 5×10⁻⁶ g/cm².

An electric component coating material was obtained by heating the particle deposit for 10 seconds using a burner or in a reducing flame of LP gas. The ambient temperature for combustion of the gas was 350° C.

### Example 4

A particle deposit was obtained by tin-plating a base sample similar to that of Example 3 under the following conditions:
Plating solution composition: the same as Example 3
Plating temperature: the same as Example 3
Current density: an average of 10 A/dm²
Current application time: 10 seconds (pulsed current application: a cycle of 100 μsec.)

The obtained particle deposit contained tin spot-deposited particles 8 arranged on the surface of the base sample such that the tin spot-deposited particles 8 had gaps therebetween, and did not pile up in the direction perpendicular to the surface of the base sample. The average diameter of the spot-deposited particles 8 was 30 nm. Further, the amount of tin in the particle deposit measured with an X-ray fluorescence analyzer (manufactured by SII NanoTechnology Inc.) was 3×10⁻⁶ g/cm².

An electric component coating material was obtained by heating the particle deposit in a similar manner to that of Example 3.

### Example 5

A particle deposit was obtained by tin-plating a base sample similar to that of Example 3 under the following conditions:

Plating solution composition: the same as Example 3

Plating temperature: the same as Example 3

Current density: 10 A/dm²

Current application time: 6 seconds

The obtained particle deposit contained tin spot-deposited particles 8 arranged on the surface of the base sample such that the tin spot-deposited particles 8 had gaps therebetween, and did not pile up in the direction perpendicular to the surface of the base sample. The average diameter of the spot-deposited particles 8 was 50 nm. Further, the amount of tin in the particle deposit measured with an X-ray fluorescence analyzer (manufactured by SII NanoTechnology Inc.) was 7.3×10⁻⁶ g/cm².

An electric component coating material was obtained by heating the particle deposit in a similar manner to that of Example 3.

### Example 6

A plated object was obtained by indium-plating a base sample similar to that of Example 3 under the following conditions:
Plating solution composition: indium sulfamate: 100 g/L surfactant: 800 mL/L
Plating solution temperature: 30° C.
Current density: 2 A/dm²
Current application time: 6 seconds

The obtained plated object contained indium spot-deposited particles 8 arranged on the surface of the base sample such that the indium spot-deposited particles 8 had gaps therebetween as viewed from above, and did not pile up in the direction perpendicular to the surface of the base sample. The average diameter of the spot-deposited particles 8 was 50 nm. Further, the amount of indium in the plated object measured with an X-ray fluorescence analyzer (manufactured by SII NanoTechnology Inc.) was 7.3×10⁻⁶ g/cm².

An electric component plating material was obtained by heating the plated object for 10 seconds using a burner or in a 250° C. reducing flame of LP gas.

### Example 7

A plated object was obtained by zinc-plating a base sample similar to that of Example 3 under the following conditions:

Plating solution composition: zinc oxide: 5 g/L
caustic soda: 100 g/L
additive: 10 g/L

Plating solution temperature: 30° C.

Current density: 2 A/c1 m²

Current application time: 5 seconds

The obtained plated object contained zinc spot-deposited particles 8 arranged on the surface of the base sample such that the zinc spot-deposited particles 8 had gaps therebetween as viewed from above, and did not pile up in the direction perpendicular to the surface of the base sample. The average diameter of the spot-deposited particles 8 was 50 nm. Further, the amount of zinc in the plated object measured with an X-ray fluorescence analyzer (manufactured by SII NanoTechnology Inc.) was 7.1×10⁻⁶ g/cm².

An electric component plating material was obtained by heating the plated object for 10 seconds using a burner or in a 500° C. reducing flame of LP gas.

### Comparative Example 2

A particle deposit was obtained by tin-plating a base sample similar to that of Example 3 under the following conditions:

Plating solution composition: the same as Example 3

Plating temperature: the same as Example 3

Current density: 10 A/dm²

Current application time: 1.5 seconds

The particle deposit contained tin spot-deposited particles 8 arranged on the surface of the base sample such that the tin spot-deposited particles 8 had gaps therebetween, and did not pile up in the direction perpendicular to the surface of the base sample. The average diameter of the spot-deposited particles 8 was 30 nm. Further, the amount of tin in the particle deposit measured with an X-ray fluorescence analyzer (manufactured by SII NanoTechnology Inc.) was 1.9×10⁻⁶ g/cm².

An electric component coating material was obtained by heating the particle deposit in a similar manner to that of Example 3.

### Comparative Example 3

A particle deposit was obtained by tin-plating a base sample similar to that of Example 3 under the following conditions:

Plating solution composition: methanesulfonic acid: 100 g/L
tin methanesulfonate: a ten-fold equivalent of tin methanesulfonate of Example 3/L
surfactant: 30 g/L

Plating temperature: 42° C.

Current density: 2 A/dm²

Current application time: 4 seconds

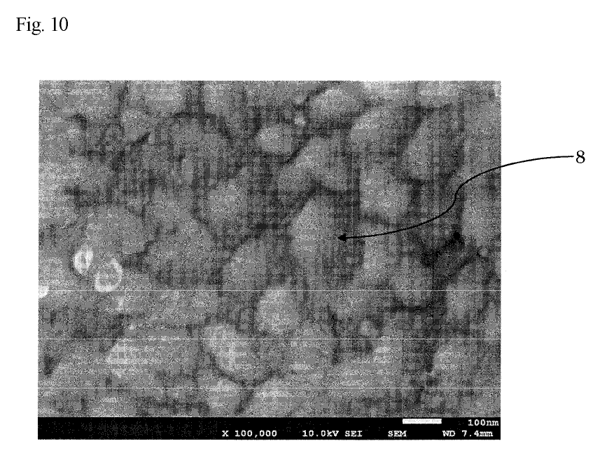

Like the particle deposit shown in FIG. 10, the obtained particle deposit contained tin spot-deposited particles 8 arranged on the surface of the base sample such that the tin spot-deposited particles 8 had no gaps therebetween and partially piled up in the direction perpendicular to the surface of the base sample, adjacent spot-deposited particles contacting each other. The average diameter of the spot-deposited particles 8 was 100 nm. Further, the amount of tin in the particle deposit measured with an X-ray fluorescence analyzer (manufactured by SII NanoTechnology Inc.) was 5×10⁻⁵ g/cm².

An electric component coating material was obtained by heating the particle deposit in a similar manner to that of Example 3.

Table 3 shows the properties of the base samples, and the properties of the electric component coating materials obtained in the examples and the comparative examples. In the table, the resistance to sulfurization represents the degree of discoloration of the sample electric component coating material when: heated at 200° C. for an hour; immersed at normal temperature for 10 minutes in a solution having a concentration of 6% by weight of ammonium sulfide; cleaned with pure water; immersed in methanol that has replaced the pure water; and blown in a nitrogen flow. The criteria are as follows. Excellent: no discoloration is observed. Very good: almost no discoloration is observed. Good: slight discoloration is observed but is acceptable. Average: discoloration is observed but is acceptable. Poor: significant discoloration is observed. Further, the contact resistance (mS)) is measured by an AC four-probe method where: the quality of the material of the probe is NS/Au; the shape of the tip of the probe is 1.0 R; the measurement current is 100 μA; and the load is 30 gf. The reflectance is measured with a U-4000 spectrophotometer at a wavelength of 450 nm.

TABLE 3

| | Reflectance | Contact resistance | Resistance to |
|---|---|---|---|
| | (%) | (mΩ) | sulfurization |
| Example 3 | 93 | 13 | Very good |
| Example 4 | 94 | 12 | Good |
| Example 5 | 90 | 16 | Very good |
| Example 6 | 95 | 10 | Excellent |
| Example 7 | 94 | 15 | Very good |
| Comparative Example 2 | 95 | 10 | Poor |
| Comparative Example 3 | 73 | 100 | Very good |
| Base sample | 96 | 2 | Poor |

### INDUSTRIAL APPLICABILITY

The present invention is suitable for use in preventing the sulfurization of silver surfaces of various apparatuses that use the surface properties of silver, such as high reflection properties and a high surface electrical conductivity and the like. In particular, the present invention is suitable for use in an optical instrument, a switch, a component contact, a component terminal, a vacuum insulation, and the like.

The electric component coating material obtained by the present invention has a low contact resistance, has a high resistance to sulfurization, and has the original brightness of silver. Thus, the electric component coating material is suitable for use as not only an electric contact material such as a terminal, a connector, or a switch, but also an electric (electronic) material, such as: a lead material of a lead wire used for an IC package, of a lead pin, or of a lead frame; a reflecting member for an illuminating apparatus such as an LED lamp; and a conductive material for a fuel cell and the like.

This application claims priority from Japanese Patent Application Nos. 2009-166298 and 2009-259454, which are incorporated herein by reference.

There have thus been shown and described a plating structure and a method for manufacturing an electric material which fulfill all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A plating structure obtained by heat-treating a silver-plated structure obtained by the steps of:
forming a silver-plated layer on a surface of a plating base; and
forming one of a tin-plated layer, an indium-plated layer, and a zinc-plated layer, having a thickness of 0.001 to 0.1 μm, on a surface of the silver-plated layer.

2. A light-emitting element accommodating support including a recess for accommodating a light-emitting element, the light-emitting element accommodating support reflecting light on a peripheral wall of the recess, Wherein the plating structure according to claim 1 is formed on the peripheral wall of the recess, a body of the light-emitting element accommodating support in the plating structure being served as the plating base.

3. A light-emitting device comprising:
the light-emitting element accommodating support according to claim 2; and
a light-emitting element mounted on the light-emitting element accommodating support.

4. A switch contact comprising a plated section having the plating structure according to claim 1.

5. A component terminal comprising a plated section having the plating structure according to claim 1.

6. A component contact comprising a plated section having the plating structure according to claim 1.

7. A coating method for obtaining the plating structure according to claim 1, comprising the steps of:
arranging one of tin, indium spot-deposited particles, and zinc spot-deposited particles spottedly deposited by a particle deposition method on a surface of a silver layer formed on a surface of a base material such that the spot-deposited particles have gaps therebetween as viewed from above, and do not pile up in a direction perpendicular to the surface of the silver layer; and
melting the spot-deposited particles by heating in a non-oxidizing atmosphere a particle deposit to obtain a film, an average diameter of the spot-deposited particles being from 20 to 80 nm, a weight per unit area of the spot-deposited particles formed on the surface of the silver layer being from 2×10⁻⁶ to 8×10⁻⁶ g/cm².
